(19) United States
(12) Patent Application Publication
(10) Pub. No.: US 2013/0288554 A1
(43) Pub. Date: Oct. 31, 2013

(54) Laminated Composite Material and Method of Making Same

(71) Applicant: MALLEN INDUSTRIES, INC., Norcross, GA (US)

(72) Inventors: Peter J. Mallen, Atlanta, GA (US); Stan W. Smith, Loganville, GA (US)

(73) Assignee: Mallen Industries, Inc., Norcross, GA (US)

(21) Appl. No.: 13/724,584

(22) Filed: Dec. 21, 2012

Related U.S. Application Data
(60) Provisional application No. 61/639,312, filed on Apr. 27, 2012.

(51) Int. Cl. B32B 38/00; B32B 5/02; B32B 7/12

(52) U.S. Cl. CPC B32B 38/1875; B32B 7/12; B32B 5/026
USPC 442/319; 156/162; 428/221; 428/317.1

(57) ABSTRACT

Laminated composite materials for industrial molded applications and methods of making same. The laminated composite material includes a fabric layer, an adhesive layer, and a backing layer, wherein the backing layer is vinyl, and wherein the fabric layer is formed from a circular-knit material, thereby providing a laminate composite material having improved stretch and moldability for industrial applications.

### CROSS REFERENCE TO RELATED APPLICATIONS

This application claims the benefit of U.S. Provisional Application No. 61/639,312, filed Apr. 27, 2012, which is incorporated herein by reference in its entirety.

### BACKGROUND OF THE INVENTION

1. Field of the Invention

The present invention relates to composite materials and, more particularly, to laminated composite materials for industrial molded applications.

2. Description of the Prior Art

Generally, it is known in the prior art to make and use composite materials for industrial applications. Traditionally, composite materials for use in industrial applications include those being formed by a cast-coating process in which a fabric is pressed onto a surface of vinyl as the vinyl is being formed. Because the vinyl is at a sufficiently high temperature when the fabric is applied to its surface, the vinyl itself serves as a bonding agent with the fabric. However, cast-coated materials have several factors that make them undesirable. First, the temperature of the vinyl at the time that the fabric is applied to it is often so high that it can damage the fabric. Additionally, certain knit materials cannot be used in the cast-coating process because of picking that would result in the fabric. Prior art cast-coated vinyl fabrics provide a stiff, hard surface, and low moldability and formability.

Furthermore, the cast-coating process is expensive, because it requires a manufacturer to have the machinery and space available to manufacture the vinyl and apply the fabric simultaneously.

Relevant prior art references include, and are exemplified by the following:

U.S. Pat. No. 4,936,937, issued Jun. 25, 1990 to Burns et al., for “Process for making a highly plasticized vinyl fabric,” which describes a laminated vinyl fabric and a process for making the same, the fabric comprising a sheet of vinyl resin with which a major proportion of plasticizer is combined, said fabric also having been made by extrusion and promptly thereafter having been adhesively laminated at a relatively low temperature with a knitted fabric at substantially only wrap pressure; and wherein in one form, the knitted fabric is of an interlock double-knit construction with one surface thereof having a relatively small number of contacts with said vinyl sheet via an intermediate adhesive. Notably, this fabric is not suitable for foam-backed molding or forming processing.

US Patent Application Publication No. 20110020590, published Jan. 27, 2011 by Yoneda et al., for “Split leather product and manufacturing method therefor,” which describes a split leather product provided with a base material comprising split leather and a skin layer laminated on a surface of the base material, the skin layer comprising entangled nonwoven fabric formed from microfine fibers, and a polymeric elastomer that impregnates the gaps in the nonwoven fabric.

US Patent Application Publication No. 20100024136, published Feb. 4, 2010 by Teakenoiri et al., for “Laminated fabric, which teaches a laminated fabric having an air permeability and a filtering capability,” including a supportive layer and a protective layer that are bonded together, wherein the protective layer is a stretchable nonwoven fabric including ultra-fine fiber; and a water-resistant layer may be further included.

U.S. Pat. No. 3,385,750, issued May 28, 1968 to McCormack et al., for Laminated fabric for upholstery and the like, which describes a laminated fabric suited to tailored upholstery applications including a polyvinyl chloride foam sheet bonded by plastisol adhesives to cotton knit and tricot knit fabrics and finished to exhibit both dimensional stability and washability.

U.S. Pat. No. 3,336,180, issued Aug. 16, 1967 by Werner, for “Dry-cleanable vinyl foam-fabric laminate,” which describes a leather-like vinyl foam-textile fabric laminate for clothing, etc. that is rendered resistant to the loss of hand and suppleness from dry cleaning by covering the vinyl foam layer, on each side, with a solid vinyl barrier layer plasticized with a plasticizer that is not extracted by dry cleaning solvents.

U.S. Pat. No. 4,933,231, issued Jun. 12, 1990 by Sieber, for “Abrasion resistant, high strength composite padded fabric material,” which describes an abrasion and tear-resistant, high strength composite laminated padded fabric material for use in fabrication of tradesmen and craftsmen work items, such as aprons and nail bags, etc., wherein the composite fabric material is a heat and pressure formed double laminate of like outer primary layers of tight-woven threads of high tenacity nylon fibers and an intermediate padding layer of cross-linked, high density, closed-cell or open-cell, flexible synthetic polymer foam.

U.S. Pat. No. 5,578,369, issued Nov. 26, 1996 by Nohr et al., for “Laminating method and products made thereby,” which teaches a method of preparing a laminate having increased peel strength and solvent resistance, including steps of applying an adhesive composition to a surface of a first sheet, exposing the adhesive to UV light, contacting it with a second sheet, and curing the composite laminate.

U.S. Pat. No. 7,901,756, issued Mar. 8, 2011 by Burr et al., for “Functional elastic textile structures,” which teaches a functional stretch laminate composite puckered fabric which is robust, laundry-durable and adaptable for securing about any three dimensional body, and a method for forming such puckered fabric; the functional stretch laminate fabric is provided with at least one functional element which can conduct electricity, conduct light, provide electromagnetic fields or provide shielding from electromagnetic fields; generally, the functional stretch laminate fabric is sufficiently robust for incorporation into garments and for applications in so-called wearable electronics.

U.S. Pat. No. 7,718,555, issued May 18, 2010 by Smith et al., for “Chemically protective laminated fabric,” teaching a fabric for chemical protective garments having at least two multilayered film laminates that are sandwiched between films of linear low density polyethylene and contain a different film from each other selected from ethyl vinyl alcohol, polyethylene terephthalate and polyamide.

U.S. Pat. No. 7,217,453, issued May 15, 2007 by Johnson et al., for a “Composite laminate structure,” describing a method and apparatus for forming a pultruded and clinced Z-axis fiber reinforced composite laminate structure.

### SUMMARY OF THE INVENTION

The present invention relates to laminated composite materials for industrial molded applications. It is an object and aspect of this invention to provide a laminated composite material having a fabric layer adhered to a vinyl backing layer. Yet another object and aspect of this invention is to provide systems and methods for making the laminated composite material having a fabric layer adhered to a vinyl backing layer.

Accordingly, a broad embodiment of this invention is directed to a laminated composite material having a stretch fabric layer adhered by an adhesive to a backing layer including vinyl, a film, a foam, and combinations thereof, wherein the laminate composite material has improved stretch and moldability for industrial applications.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates the layers of an exemplary laminated composite material, according to one embodiment of the present invention.

FIG. 2 is a schematic of an exemplary system for making a laminated composite material, according to one embodiment of the present invention.

FIG. 3 is a flowchart of an exemplary method for making a laminated composite material, according to one embodiment of the present invention.

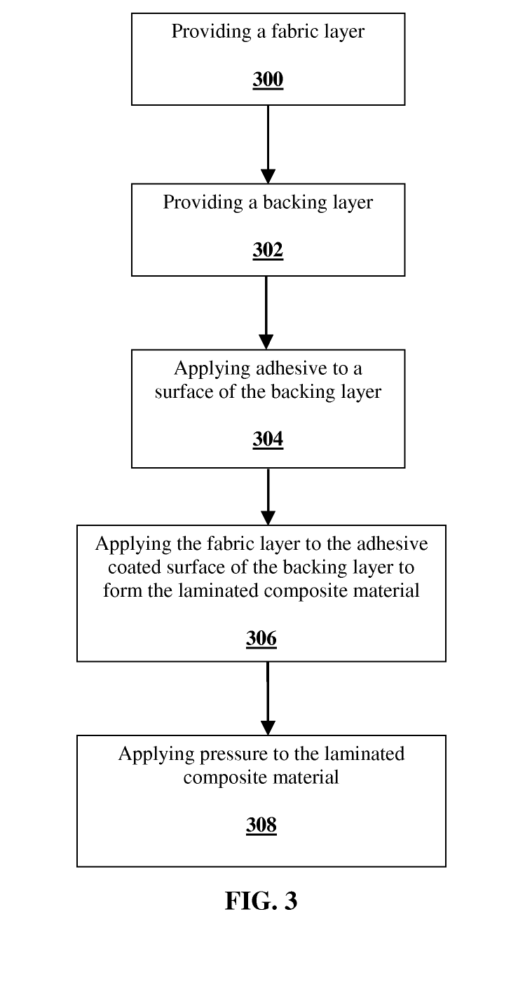

### DETAILED DESCRIPTION OF THE INVENTION

Referring now to the drawings in general, the illustrations are for the purpose of describing a preferred embodiment of the invention and are not intended to limit the invention thereto.

The present invention provides laminated composite materials for industrial molded applications and to systems and methods of making same, wherein the laminate composite material has improved stretch and moldability for industrial applications. Preferably, a laminated composite material is provided, including a stretch fabric layer adhered by an adhesive to a backing layer including vinyl, a film, a foam, and combinations thereof. Also preferably, the laminated composite material of the present invention is suitable for industrial applications including a variety of additional processing, such as by way of example and not limitation, molding and forming operations wherein the laminated composite material is stretched and then molded and/or formed into complex shapes and configurations and then fixed in that form (e.g., automotive seating including the laminated composite material applied to a foam and formed into the shape of a seat component having convex and concave curves, lines, etc).

By contrast to the prior art, including cast-coated vinyl fabrics, the laminated composite material of the present invention includes a circular-knit stretch fabric constructed and configured on the outer (viewable) surface that is adhesively affixed and bonded to a backing material, including vinyl, film, foam, and combinations thereof, using an adhesive lamination process, which provides significantly enhanced moldability and formability, while also providing a softer finish or exposed surface. Significantly, the improved or enhanced (increased) moldability is a key feature of the laminated composite material according to embodiments of the present invention; beneficially, softness on the exposed surface of the stretch fabric layer is also improved when compared with prior art. Stretch and moldability for industrial applications are critical performance characteristics that are provided by the laminate composite material of the present invention, and they provide for reduced waste when the material is used in industrial (molded fabric) applications. By way of example and not limitation, moldable applications include any application of the material to be stretched and shaped to form and retain a contoured shape after processing, including outdoor seating, automotive applications for seating, door panels, sun visors, sun roofs, wall/floor/roof panels, and the like. Notably, prior art cast-coated vinyl fabrics, which include a knit fabric pressed into the surface of the vinyl as it is being formed (wherein the vinyl itself functions to bond or adhere the knit fabric to the vinyl), provide a stiffer, harder surface, and reduced moldability and formability.

In one embodiment of the present invention, the laminated composite material includes a fabric layer adhered to a backing layer with an adhesive, wherein the backing layer includes vinyl, and wherein the fabric layer is formed from a circular-knit material. The backing layer may further include a film, a foam, and combinations thereof. In preferred embodiments of the present invention, the fabric layer is selected from circular knit material, including a single-knit fabric or a double-knit fabric. Yarn components of the fabric are preferably synthetic yarns, preferably selected from the group consisting of nylon, polyester, and combinations thereof. The adhesive may be embodied as an adhesive layer applied and positioned between the fabric layer and the backing layer. In this case, the adhesive layer is positioned between the fabric layer and the backing layer to adhere the fabric layer to the backing layer. Preferably, the adhesive is a urethane adhesive.

In systems for making the laminated composite material described herein, the system includes a series of rollers for processing the fabric layer and the backing layer with an adhesive applied therebetween (the adhesive may be applied as an adhesive layer) to form the laminated composite material. In one embodiment, the series of rollers includes a first feed roller having a length of a fabric disposed thereon, a second feed roller having a length of a backing material disposed thereon, and means for applying an adhesive to a surface of the backing material. The system can also include at least one pair of cooperating nip rollers and a final product roller. In one embodiment, the first feed roller is configured to feed the fabric toward the nip rollers and the second feed roller is configured to feed the backing material toward the nip rollers. The means for applying the adhesive to the backing material can be positioned between the second feed roller and the nip rollers. In various aspects, the nip rollers are configured to join the fabric to the adhesive-coated surface of the backing material and to apply a selected amount of pressure to the joined material to form the laminated composite material. The final product roller can be configured to collect the laminated composite material.

In one embodiment of a system according to the present invention, the system for making the laminated composite material, includes: a first feed roller having a length of a fabric disposed thereon; a second feed roller having a length of a backing material disposed thereon; an adhesive applicator, for applying the adhesive to a surface of the backing material; at least one pair of cooperating nip rollers; and a final product roller, wherein the first feed roller is configured to feed the fabric toward the nip rollers, wherein the second feed roller is configured to feed the backing material toward the nip rollers, wherein the adhesive applicator is positioned between the second feed roller and the nip rollers, wherein the nip rollers are configured to join the fabric to the adhesive-coated surface of the backing material and to apply a selected amount of pressure to the joined material to form the laminated composite material, and wherein the final product roller is configured to collect the laminated composite material.

In a method of making the laminated composite fabrics according to the present invention, the steps include: providing a fabric layer, providing a backing layer, applying adhesive to a surface of the backing layer, and applying the fabric layer to the adhesive-coated surface of the backing layer. Additionally, the step of applying pressure to the composite material is provided.

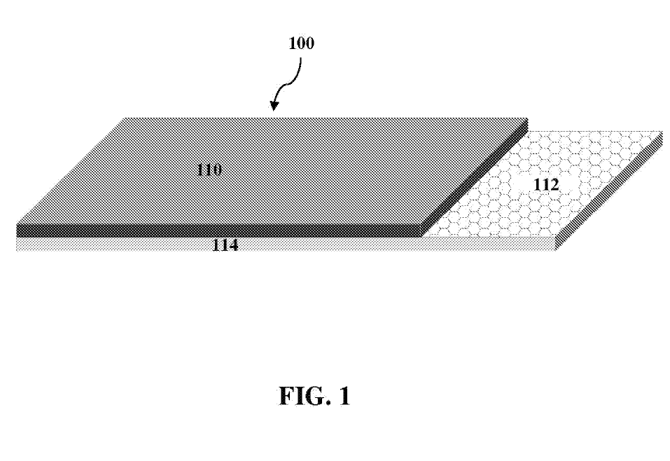

Referring now to FIG. 1, the material 100 can comprise several layers, including a fabric layer 110, an adhesive layer 112, and a backing layer 114. The adhesive layer can be positioned between the fabric layer and the backing layer to adhere the fabric layer to the backing layer.

The adhesive layer 112 can be any adhesive that adheres the fabric layer to the backing layer. In one particular embodiment, the adhesive can comprise a urethane adhesive. According to various embodiments, the amount of adhesive used will be the minimum required to achieve an acceptable bond between the fabric layer and the backing layer for the particular application in which the final material 100 will be used. For example, the material can be used in industrial molding applications, such as, but not limited to, the manufacture of turf seating (lawnmower seats and the like), golf cart seats, automotive parts, etc. The amount of adhesive used will be the minimum required to achieve an acceptable bond for the ultimate application of the material. According to various embodiments, the backing layer 114 can be vinyl, film, or foam. The film can be a nylon film.

In a further aspect, the backing layer is surface-treated prior to being laminated to the fabric layer. By way of example and not limitation, the backing layer is processed according to a Corona treatment, as is known in the art to include a process of high speed oxidation on the polymer surface, which increases surface bonding strength by creating polar molecules on the surface. In this example, the treated backing layer will better adhere to the fabric layer. Methods of Corona treatment include processing the fabric with Corona treaters or treatment machines wherein roller treaters wherein either bare rollers or silicone sleeved rollers are used in conjunction with ceramic tubes and electrode system components to which high voltage is applied as the fabric moves through the machine.

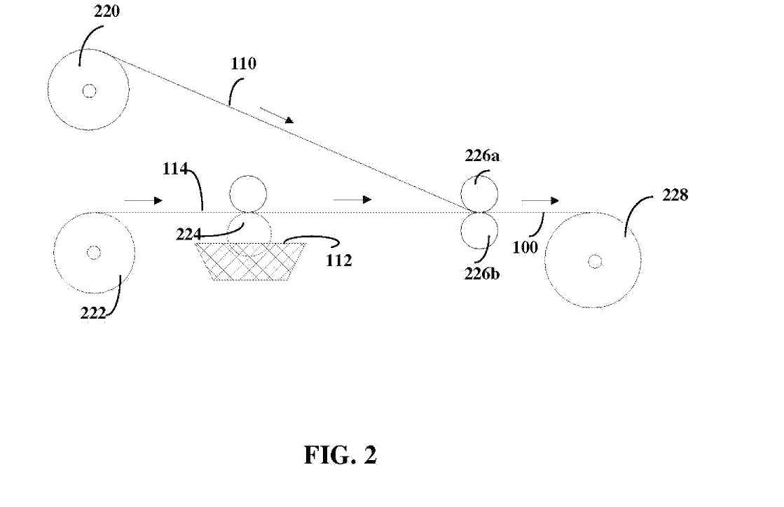

FIG. 2 illustrates an exemplary system 200 for making a laminated composite material 100, such as described above. FIG. 2 is exemplary only, inasmuch other systems can be used to make the laminated composite materials described herein. The exemplary system includes a plurality of rollers, including at least a first feed roller 220 having a length of fabric 110 disposed on it. The first feed roller 220 are configured to feed the fabric forward, toward the nip rollers 226a, 226b. The first feed roller 220 can be an overfeed or driven roller to allow the tension of the fabric to be controlled as it is fed forward. A second feed roller 222 is provided having a length of backing material 114 disposed on it. The second feed roller 222 can also be configured to feed the backing material toward the nip rollers.

In one embodiment of the present invention, the system further includes an adhesive applicator for applying the adhesive (or adhesive layer) to a surface of the backing material. According to one embodiment, the adhesive is applied to the surface of the backing layer that is joined with the fabric layer. In FIG. 2, the adhesive 112 is illustrated as being applied to the underside or under surface of the backing layer. Alternatively, in the case where the upper surface of the backing layer is to be laminated to or joined to the fabric layer, then the adhesive is applied to that surface. As illustrated, the adhesive is applied to the backing layer with a roller 224 that rolls through the adhesive 112 and then rolls the adhesive onto the backing layer in one smooth and continuous layer, thereby coating the surface of the backing material with the adhesive. In another embodiment, the adhesive may be heated to a specific temperature to allow it to be applied to the backing layer in a predetermined quantity and/or at the predetermined thickness, and also at a select, predetermined temperature that allows for maximal adhesion to the fabric layer. Preferably, the select, predetermined temperature is the lowest temperature that provides adhesion without delamination. As shown in FIG. 2, the adhesive is applied to the backing material between the second feed roller 222 and the nip rollers 226a, 226b.

Referring again to FIG. 2, after the adhesive has been applied to the backing material, the fabric is applied to the adhesive-covered backing material with use of at least one pair of cooperating nip rollers 226a, 226b. The placement and size of the nip rollers is selected to apply a predetermined pressure to the material after the fabric layer has been adhered to the backing layer, wherein the pressure ensures adhesion without delamination. The laminated composite material 100 is then rolled onto a final product roller 228, which is configured to collect the laminated composite material.

According to other embodiments, more rollers can be provided than those shown in FIG. 2, which is illustrative of one embodiment of the present invention. For example, various other rollers can be provided to control the tension on the fabric layer, the backing layer, and/or the final material. Additional pairs of cooperating nip rollers can also be provided to apply pressure to the final material after the fabric layer has been adhered to the backing layer, but before being rolled onto the final product roller 228.

In a further embodiment, surface treatment components for treating the surface of the backing layer can be provided as part of the system. In one embodiment, the surface treatment components are positioned so that the backing layer is surface treated before having the adhesive applied to its surface. In a specific embodiment, the surface treatment for the backing layer includes components and/or systems for Corona treatment.

Methods are also provided for making a laminated composite material as discussed herein. The method, in one aspect, comprises the steps of providing a fabric layer 300 and providing a backing layer 302. The method further comprises applying adhesive to one surface of the backing layer 304, and applying the fabric layer to the adhesive-coated surface of the backing layer 306. In a further aspect, after the fabric layer has been applied to the backing layer, the method comprises applying pressure to the laminated composite material 308. For example, the laminated composite material can be passed through means for applying pressure to the laminated composite material, such as, but not limited to, the at least one pair of cooperating nip rollers discussed above. The amount of pressure can be selected to achieve the desired amount of adhesion between the layers of the composite material.

Table 1 shows a chart showing comparative test data including the material of the present invention. Notably, the material of the present invention (labeled “Mallen” in the column heading) provides the following improvements compared with traditional cast-coated material of the prior art: increased breaking strength in both length and width directions; increased elongation percentage in both length and width directions; increased trapezoidal tear strength in both length and width directions; increased puncture resistance; and increased bursting strength. Also, burn resistance and abrasion resistance were comparable between the material of the present invention and the prior art cast-coated material.

TABLE 1
Cast-coated vs Mallen Composite Black Testing Results Comparison

| | | Cast- | | % |
|---|---|---|---|---|
| | | coated | Mallen | Increase |
| Breaking Strength - lbf | Length | 197.28 | 208.88 | 5.88% |
| ASTM D751-06-A-Grab | Width | 162.35 | 190.77 | 17.51% |
| Elongation - % | Length | 124.19 | 150.79 | 21.42% |
| ASTM D751-06-A-Grab | Width | 201.45 | 249.23 | 23.72% |
| Trapezoidal Tear - lbf | Length | 37.48 | 63.99 | 70.73% |
| ASTM D751-06 | Width | 38.89 | 56.68 | 45.74% |
| Puncture Resistance - lbf | | 31.4 | 36.5 | 16.24% |
| ASTM D751-06 | | | | |
| Bursting Strength - psi | | 244 | 256 | 4.92% |
| ASTM D751-06-Mullen- | | | | |
| Diaphragm | | | | |
| Burn Resistance - FMVSS 302 | Length | Pass | Pass | |
| | Width | Pass | Pass | |
| Abrasion Resistance | Color | 5.0/5.0 | 5.0/5.0 | |
| | Change | | | |
| CFFA 1a-Wyzenbeek- | Wear | None | None | |
| 30000 cycles | | | | |
| #8 Cotton Duck | Pilling | 5.0/5.0 | 5.0/5.0 | |
| 2 lbs pressure, 6 lbs tension | | | | |

Certain modifications and improvements will occur to those skilled in the art upon a reading of the foregoing description. In an alternative embodiment, the vinyl side of the composite material may be used as the face side (outward facing side). By way of example and not limitation, this alternative embodiment is provided for outdoor, water-resistant applications, such as seating for automated carts, golf carts, lawn equipment, tractors, etc. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A laminated composite material for industrial molded applications comprising: a multilayer material further comprising a fabric layer, an adhesive layer, and a backing layer; wherein the adhesive layer is positioned between the fabric layer and the backing layer for fixedly attaching the fabric layer and the backing layer; and wherein the multilayer material is moldable to conform and retain a shape of a three-dimensional object.

2. The material of claim 1, wherein the multilayer material is moldable to conform and substantially retain the shape of an industrial seating component.

3. The material of claim 1, wherein the multilayer material is moldable to conform and substantially retain the shape of an automotive interior component.

4. The material of claim 1, wherein the multilayer material is moldable to conform and substantially retain the shape of an automotive exterior component.

5. The material of claim 1, wherein the backing layer is selected from the group consisting of a vinyl backing layer, a film backing layer, and a foam backing layer.

6. The material of claim 1, wherein the adhesive is a urethane adhesive.

7. The material of claim 1, wherein the adhesive is applied in the minimum amount required to adhere the layers.

8. The material of claim 1, wherein the adhesive is applied in an amount required to adhere the layers and to achieve an acceptable bond between the fabric layer and the backing layer.

9. The material of claim 8, wherein the material has a breaking strength of at least about 200 lbf in length and at least about 190 lbf in width.

10. The material of claim 1, wherein the material has improved stretch and moldability for industrial applications when compared with a cast-coated material.

11. The material of claim 1, wherein the material has the following properties compared with a cast-coated material: increased breaking strength in both length and width directions; increased elongation percentage in both length and width directions; increased trapezoidal tear strength in both length and width directions; increased puncture resistance; and increased bursting strength.

12. The material of claim 1, wherein the backing layer is surface-treated prior to being laminated and adhered to the fabric layer.

13. The material of claim 1, wherein the backing layer is processed according to a Corona treatment.

14. The material of claim 1, wherein the fabric layer is a circular knit fabric.

15. A laminated composite material for industrial molded applications comprising: a circular-knit stretch fabric constructed and configured to provide an outer surface and an exposed surface, the outer surface being adhesively affixed and bonded to a backing material with an adhesive, the material providing increased moldability and formability when applied to an object.

16. The material of claim 15, wherein the material further includes a softer finish on the exposed surface compared with a cast-coated material.

17. A method for manufacturing the laminated composite material of claim 1, comprising the steps of: providing a fabric layer; providing a backing layer having a top surface and an under surface; applying an adhesive to the under surface of the backing layer; contacting the fabric layer with the adhesive and the backing layer; maintaining the fabric layer and the backing layer in tension while rolling the laminated multilayer fabric onto a collection roll.

18. The method of claim 17, wherein the step of applying the adhesive is provided to an outer surface of the fabric layer; contacting the fabric layer and adhesive with the upper surface of the backing layer, while both layers are held under tension by rollers.

19. The method of claim 17, wherein the adhesive is applied to the backing layer with a roller that rolls through the adhesive and then rolls the adhesive onto the backing layer in one smooth and continuous layer, thereby coating the surface of the backing material with the adhesive.

20. The method of claim 17, wherein the adhesive is heated to a temperature that allows it to be applied to the backing layer in a predetermined quantity and/or at the predetermined thickness.

21. The method of claim 20, wherein the adhesive provides for maximal adhesion to the fabric layer.

22. The method of claim 20, wherein the temperature is the lowest temperature that provides adhesion without delamination.
